(19) United States
(12) Patent Application Publication
(10) Pub. No.: US 2010/0314315 A1
(43) Pub. Date: Dec. 16, 2010

(54) Apparatus of extracting aromatic compounds from plants using a solvent in sub-zero temperature and process thereof

(76) Inventors: Kai Lin, Xiamen (CN); Hongliang Lu, Xiamen (CN); Pengfei Ma, Xiamen (CN)

Correspondence Address: SAM CHEN, 7F-1, 293, ROOSEVELT ROAD, SEC 3, TAIPEI, TW

(21) Appl. No.: 12/571,413

(22) Filed: Sep. 30, 2009

(30) Foreign Application Priority Data
Jun. 15, 2009 (CN) 200910111996.2

(51) Int. Cl. B01D 11/00; B01D 17/00; B01D 5/00; B01D 1/00

(52) U.S. Cl. 210/634; 422/280

(57) ABSTRACT

An extracting apparatus includes a first flask for containing raw material and solvent for dissolving the raw material to form a solution; second flasks each disposed in a cooling bath and containing a quantity of aromatic compounds absorbent fluid; a third flask disposed in a third cooling bath; and thermometers each disposed in each of the first, second, and third cooling baths. The first flask is connected to the first one of the second flasks after removing from the first cooling bath. The second flasks are interconnected. The third flask is connected to the last one of the second flasks. The solution evaporates to flow vapors through the second flasks sequentially, vaporized aromatic compounds of the solution are absorbed by the aromatic compounds absorbent fluid, and vaporized solvent of the solution reaches the third flask to be condensed and collected therein. An extracting process is also provided.

### BACKGROUND OF THE INVENTION

1. Field of Invention

The invention relates to extractions and more particularly to an apparatus of extracting aromatic compounds from odorous plants using a solvent in a condition of low temperature (e.g., in a range of −10° C. to 0° C.) with the solvent being collected at another low temperature (e.g., in a range of −20° C. to 0° C.) for recycle and process thereof.

2. Description of Related Art

Extractions, distillations, etc. have been used for obtaining fragrant oils and compounds from odorous raw materials (e.g., herbs). These conventional processes are disadvantageous due to low efficiency, high energy consumption, and high solvent consumption.

Recently, a number of techniques such as SBE (semi-biological extraction), MAE (microwave accelerated extraction), supercritical fluid extraction, ultrasonic extraction, and centrifugal separation have been devised. Solvents such as alcohol, water, liquid carbon dioxide, petroleum ether, methyl dichloride, and ethyl acetate are typically used in the extraction.

However, a number of disadvantages have been found in above typical processes. For example, obtained aromatic compounds have been damaged in the process due to high temperature, high atmospheric pressure, and toxic compounds of solvent. To the worse, the obtained aromatic compounds may contain toxic compounds which are very difficult of removing. Thus, a need for improvement exists.

### SUMMARY OF THE INVENTION

It is therefore one object of the invention to provide an apparatus of extracting aromatic compounds from plants using a solvent in sub-zero temperature.

It is another object of the invention to provide a process of extracting aromatic compounds from plants using a solvent in sub-zero temperature.

The above and other objects, features and advantages of the invention will become apparent from the following detailed description taken with the accompanying drawings.

### BRIEF DESCRIPTION OF THE DRAWINGS

FIG. 1 is a side elevation of a bath with a first flask disposed therein in which coolant is contained in the bath and the first flask contains a raw material dissolved by a solvent showing a portion of an extracting apparatus according to the invention;

FIG. 2 is a side elevation of an arrangement of the first flask, a plurality of second flasks for absorbing aromatic compounds, and a third flask for collecting solvent for recycle showing the remaining portions of the extracting apparatus according to the invention; and

FIG. 3 is a flowchart depicting an extracting process for use with the extracting apparatus for obtaining aromatic compounds according to the invention.

### DETAILED DESCRIPTION OF THE INVENTION

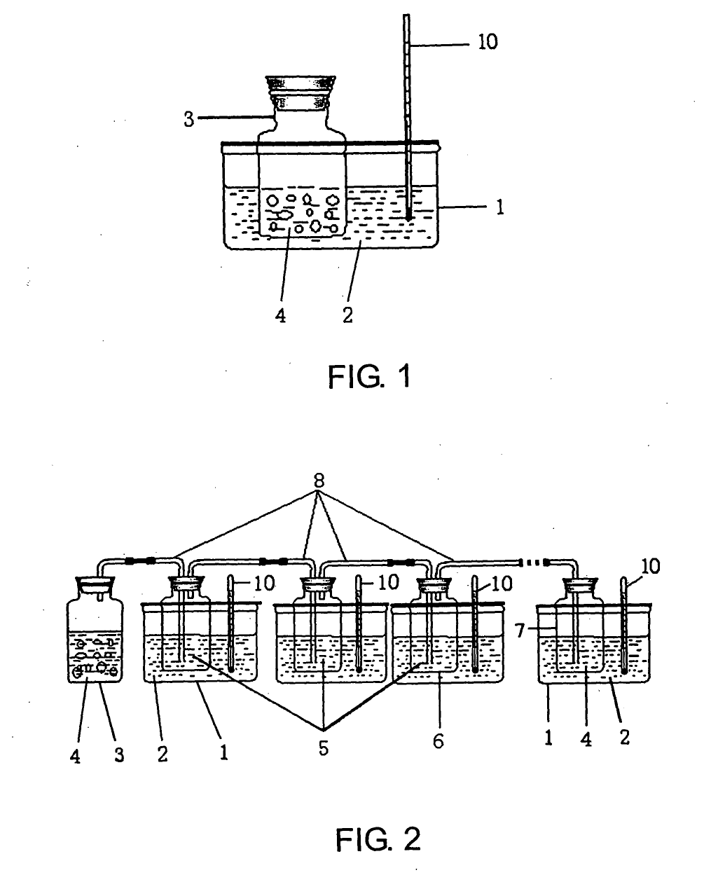

Referring to FIGS. 1 and 2, an apparatus of extracting aromatic compounds from plants using a solvent in sub-zero temperature in accordance with the invention is shown. The apparatus comprises the following components as discussed in detail below.

As shown in FIG. 1, a first flask 3 containing a raw material to be extracted is provided in a bath 1. A quantity of coolant 2 is contained in the bath 1. That is, the bath 1 is a cooling bath. A thermometer 10 is mounted in the bath 1. The bath 1 is cooled by the coolant 2. The bath 1 is maintained in a temperature range of −10° C. to 0° C. and is under standard atmospheric pressure. A predetermined amount of solvent 4 is added into the first flask 3 prior to sealing the first flask 3. Preferably, the solvent 4 is odorless and has a low boiling point (e.g., in a temperature range of −5° C. to 10° C.), i.e., being easy to evaporate. The solvent 4 can dissolve the raw material in the first flask 3 to form a homogeneous solution after a predetermined period of time.

As shown in FIG. 2, the first flask 3 has been removed from the bath 1 shown in FIG. 1. The first flask 3 is connected to a first one of a plurality of (e.g., three) second flasks 6 by piping 8. The second flasks 6 are also connected together by piping 8. Each second flask 6 is placed in a bath 1 containing coolant 2. The baths 1 are maintained in a temperature range of −10° C. to 0° C. Each second flask 6 contains a quantity of aromatic compounds absorbent fluid 5. An outlet of a section of the piping 8 in the second flask 6 should be inserted into the aromatic compounds absorbent fluid 5 and an inlet thereof should be disposed above the aromatic compounds absorbent fluid 5. A thermometer 10 is mounted in each bath 1. The first flask 3 and the baths 1 are placed in a condition of room temperature (e.g., in a temperature range of 20° C. to 25° C.) and are under standard atmospheric pressure. Hence, the solution in the first flask 3 quickly evaporates by absorbing heat. The vaporized aromatic compounds and the vaporized solvent 4 of the solution pass through the second flasks 6 sequentially. The vaporized aromatic compounds of the solution, based on different boiling points of its components, are absorbed by the aromatic compounds absorbent fluid 5. Preferably, the vaporized solvent 4 generated by evaporating the solution substantially does not react with the aromatic compounds absorbent fluid 5. The collected aromatic compounds can be used as essential oils, perfumery, medicinal, or the like.

A third flask 7 is connected to the last one of the second flasks 6 by the piping 8. The third flask 7 is placed in a bath 1 with a quantity of coolant 2 contained therein. A thermometer 10 is mounted in the bath 1. The bath 1 is maintained in a predetermined low temperature (e.g., in a temperature range of −20° C. to 0° C.) and is under standard atmospheric pressure.

The vaporized solvent 4 of the solution finally reaches the third flask 7. The vaporized solvent 4 of the solution is cooled again to be collected in the third flask 7 in the form of liquid. The liquid solvent 4 can be recycled for future use.

Preferably, the thermometer 10 can measure a temperature range of −20° C. to 60° C. Further, temperatures of the baths 1 not including the rightmost bath 1 in FIG. 2 are not required to be the same.

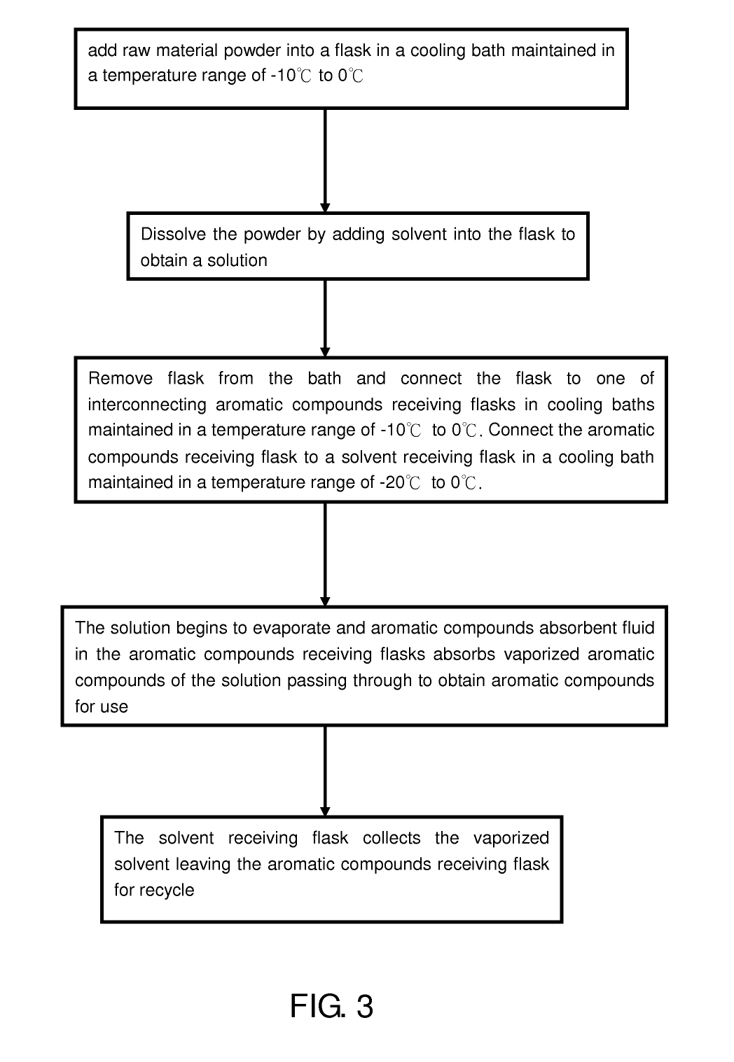

Referring to FIG. 3 in conjunction with FIGS. 1 and 2, a flowchart depicting a process of extracting aromatic compounds from plants using a solvent in sub-zero temperature in accordance with the invention is illustrated.

As shown in FIG. 1, add about 30 g of honeysuckle powder into a first flask 3 in a bath 1. A quantity of coolant 2 is contained in the bath 1. A thermometer 10 is mounted in the bath 1. The bath 1 is cooled by the coolant 2. The bath 1 is maintained in a temperature range of −10° C. to 0° C. and is under standard atmospheric pressure. Next, add about 150 g of a selected solvent 4 into the first flask 3 and seal the first flask 3. The solvent 4 begins to dissolve the honeysuckle powder. A homogeneous solution is formed in the first flask 3 after about 15 hours. These are first and second steps of the process. Note that a person should watch the thermometer 10 regularly since the temperature of the bath 1 may increase as the first and second steps evolve. Further, the person should add coolant 2 into the bath 1 at any time in order to maintain the bath 1 at the temperature range of −10° C. to 0° C.

As shown in FIG. 2, the first flask 3 has been removed from the bath 1 shown in FIG. 1. Connect the first flask 3 to a first one of a plurality of (e.g., three) second flasks 6 by piping 8. The second flasks 6 are also connected together by the piping 8. Each second flask 6 is placed in a bath 1 containing coolant 2. The baths 1 are maintained in a temperature range of −10° C. to 0° C. Each second flask 6 contains a quantity of aromatic compounds absorbent fluid 5. A thermometer 10 is mounted in each bath 1. The first flask 3 and the baths 1 are placed in a condition of room temperature (e.g., in a temperature range of 20° C. to 25° C.) and are under standard atmospheric pressure. Hence, the solution in the first flask 3 quickly evaporates by absorbing heat. The vaporized aromatic compounds and the vaporized solvent 4 of the solution pass through the second flasks 6 sequentially. The vaporized aromatic compounds of the solution, based on different boiling points of its components, are absorbed by the aromatic compounds absorbent fluid 5. The collected aromatic compounds can be used as essential oils, perfumery, medicinal, or the like. These are third and fourth steps of the process. Note that a person should watch the thermometer 10 regularly since the temperature of each bath 1 may increase as the third and fourth steps evolve. Further, the person should add coolant 2 into any baths 1 at any time in order to maintain the baths 1 at the temperature range of −10° C. to 0° C.

The vaporized solvent 4 of the solution finally reaches a third flask 7 which is connected to the last one of the second flasks 6 by the piping 8. The third flask 7 is placed in a bath 1 with a quantity of coolant 2 contained therein. A thermometer 10 is mounted in the bath 1. The bath 1 is maintained in a predetermined low temperature (e.g., in a temperature range of −20° C. to 0° C.) and is under standard atmospheric pressure. The vaporized solvent 4 of the solution is cooled again to be collected in the third flask 7. The liquid solvent 4 can be recycled for future use. This is the fifth step of the process.

While the invention herein disclosed has been described by means of specific embodiments, numerous modifications and variations could be made thereto by those skilled in the art without departing from the scope and spirit of the invention set forth in the claims.

What is claimed is:

1. An extracting apparatus comprising:
a first flask for containing a predetermined amount of raw material to be extracted and a predetermined amount of solvent for dissolving the raw material, the first flask being sealed and temporarily disposed in a first cooling bath maintained at a first predetermined temperature until a solution is formed;
a plurality of second flasks each disposed in a second cooling bath maintained at the first predetermined temperature and containing a quantity of aromatic compounds absorbent fluid;
a third flask disposed in a third cooling bath maintained at a second predetermined temperature; and
a plurality of thermometers each disposed in each of the first, second, and third cooling baths;
wherein the first flask is connected to the first one of the second flasks after removing from the first cooling bath, the second flasks are interconnected, and the third flask is connected to the last one of the second flasks such that the solution in the first flask evaporates to flow vapors through the second flasks sequentially, vaporized aromatic compounds of the solution are absorbed by the aromatic compounds absorbent fluid, and vaporized solvent of the solution reaches the third flask to be condensed and collected therein.

2. The extracting apparatus of claim 1, wherein the first predetermined temperature is in a range of −10° C. to 0° C.

3. The extracting apparatus of claim 1, wherein the second predetermined temperatures is in a range of −20° C. to 0° C.

4. The extracting apparatus of claim 1, wherein the solvent has a boiling point in a temperature range of −5° C. to 10° C.

5. The extracting apparatus of claim 1, wherein each of the thermometers is capable of measuring a temperature range of −20° C. to 60° C.

6. The extracting apparatus of claim 1, wherein the vaporized solvent of the solution substantially does not react with the aromatic compounds absorbent fluid.

7. An extracting process comprising the steps of:
(a) adding a predetermined weight of a predetermined powder into a first flask in a first cooling bath maintained at a first predetermined temperature;
(b) adding a predetermined weight of solvent into the first flask and sealing the first flask so that the solvent dissolves the predetermined powder to form a homogeneous solution after a predetermined period of time;
(c) removing the first flask from the first cooling bath; and
(d) connecting the first flask to a first one of a plurality of second flasks, interconnecting the second flasks, and connecting a third flask to the last one of the second flasks wherein a quantity of aromatic compounds absorbent fluid is contained in each of the second flasks, each of the second flasks is placed in a second cooling bath maintained at the first predetermined temperature, the third flask is placed in a third cooling bath maintained at a second predetermined temperature, the solution evaporates to flow vaporized aromatic compounds thereof to the second flasks for absorption by the aromatic compounds absorbent fluid, and the vaporized solvent of the solution reaches the third flask to be condensed and collected.

8. The extracting process of claim 7, wherein the first predetermined temperature is in a range of −10° C. to 0° C.

9. The extracting process of claim 7, wherein the second predetermined temperatures is in a range of −20° C. to 0° C.

10. The extracting process of claim 7, wherein the solvent has a boiling point in a temperature range of −5° C. to 10° C.

11. The extracting process of claim 7, wherein the vaporized solvent of the solution substantially does not react with the aromatic compounds absorbent fluid.
